(19) United States
(12) Patent Application Publication
(10) Pub. No.: US 2004/0249818 A1
(43) Pub. Date: Dec. 9, 2004

(54) Ride-share request matching system and method

(76) Inventor: Stephen John Isaac, Petersfield (GB)

Correspondence Address: Shoemaker & Mattare, Suite 100, 10 Post Office Road, Silver Spring, MD, 20910, US

(21) Appl. No.: 10/493,230

(22) PCT Filed: Nov. 7, 2002
(86) PCT No.: PCT/GB02/05060

(30) Foreign Application Priority Data
Nov. 7, 2001 (GB) 0126809.3

(51) Int. Cl. G06F 17/30

(52) U.S. Cl. 707/10

(57) ABSTRACT

The present invention relates to a real-time, ride-share request matching system for and method of matching persons registered as lift requirers and requiring a lift to persons registered as lift providers and available to consider providing lifts such as to enable sharing of vehicle journeys, each of the lift requirers having a mobile communicator for making lift requests and each of the lift providers having a mobile communicator for addressing lift requests, the method comprising the steps of: receiving lift requests, each including a voice message, from lift requirers; relaying lift requests to respective lift providers as determined by the locations of the respective lift requirers; and receiving replies from lift providers to respective lift requests in accepting the same.

The present invention relates to a real-time, ride-share request matching system for matching persons registered as lift requirers and requiring a lift to persons registered as lift providers and available to consider providing lifts, such as to enable the sharing of personal vehicle journeys, in particular car journeys.

For many reasons, principally environmental, there is a general desire, particularly by governmental bodies, to reduce the number of personal vehicle journeys. Improving public transport is seen as the key to achieving this goal, but, even with the necessary investment to improve public transport, timetable and route restrictions will always restrict the use of public transport. It is perceived that personal vehicles, such as cars, which have the ability to go anywhere and at anytime, will remain a dominant form of transport.

The sharing of vehicle journeys increases the relative number of people who travel in vehicles, and thus reduces the number of vehicle journeys per person, but is currently often difficult to arrange, and is then only really effective for defined routes, for example, in sharing a lift to work, and, usually because of security fears, is only utilized when the sharing persons know each other.

It is thus an aim of the present invention to provide a real-time, ride-share request matching system and method which provides for the more efficient, but yet secure, use of vehicle journeys by increasing the relative number of people travelling in vehicles.

In one aspect the present invention provides a real-time ride-share request matching system for matching persons registered as lift requirers and requiring a lift to persons registered as lift providers and available to consider providing lifts such as to enable sharing of vehicle journeys, each of the lift requirers having a mobile communicator for making lift requests and each of the lift providers having a mobile communicator for addressing lift requests, the system comprising: a request handling module for receiving lift requests, each including a voice message, from lift requirers; a communications network for relaying lift requests to respective lift providers as determined by the locations of the respective lift requirers; and a reply handling module for receiving replies from lift providers to respective lift requests in accepting the same.

In another aspect the present invention provides a real-time ride-share matching method for matching persons registered as lift requirers and requiring a lift to persons registered as lift providers and available to consider providing lifts such as to enable sharing of vehicle journeys, each of the lift requirers having a mobile communicator for making lift requests and each of the lift providers having a mobile communicator for addressing lift requests, the method comprising the steps of: receiving lift requests, each including a voice message, from lift requirers; relaying lift requests to respective lift providers as determined by the locations of the respective lift requirers; and receiving replies from lift providers to respective lift requests in accepting the same.

In essence, the present invention provides a real-time, location-based request matching system and method which enables the sharing of vehicle journeys by one or more persons who are not necessarily known to each other.

The present invention has been developed to provide for the more efficient and secure use of vehicle journeys, and it is envisaged that the present invention could be allied with other incentives, such as to provide discounted vehicle tax in accordance with the number and length of shared journeys made in a certain period, or employer benefits, particularly where the shared journeys are with work colleagues.

The present invention is to be known as the Travelshare™ ride-sharing system.

Preferred embodiments of the present invention will now be described hereinbelow by way of example only with reference to the accompanying drawing, in which:

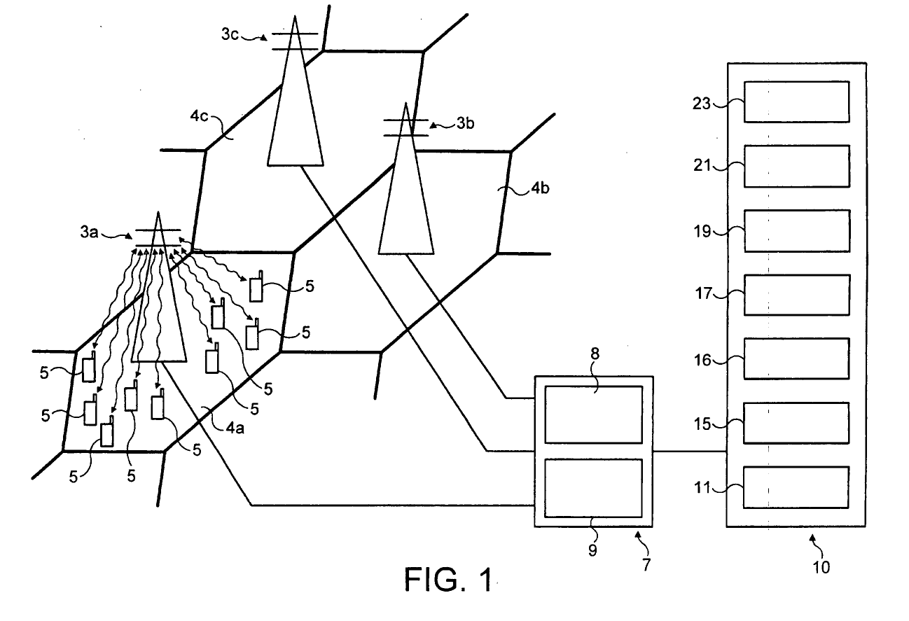

FIG. 1 schematically illustrates a ride-share request matching system in accordance with a preferred embodiment of the present invention.

The system comprises a wireless communications network, in this embodiment comprising a plurality of transmitter/receiver units 3a, 3b, 3c, each assigned to a respective geographic zone 4a, 4b, 4c, which communicate with a plurality of mobile communicators 5, and a communications unit 7 for controlling communication between respective ones of the transmitter/receiver units 3a, 3b, 3c and the mobile communicators 5 and recording the locations of the mobile communicators 5.

In this embodiment the wireless communications network comprises a cellular radio communications network, where the mobile communicators 5 are cellular radio communicators, typically mobile telephones or PDAs, and the geographic zones 4a, 4b, 4c assigned to each of the respective transmitter/receiver units 3a, 3b, 3c are cells, each identifiable by a cell id.

In this embodiment the transmitter/receiver units 3a, 3b, 3c are configured to broadcast to any mobile communicators 5 in the associated geographic zone 4a, 4b, 4c, and the mobile communicators 5 of registered lift providers are configured such as to be responsive to communications so broadcast by the transmitter/receiver units 3a, 3b, 3c. For the purposes of exemplification, a plurality of mobile communicators 5 located in one geographic zone 4a are illustrated as being in broadcast communication with the transmitter/receiver unit 3a associated with the one geographic zone 4a.

In this embodiment the mobile communicators 5 of registered lift providers are configured, where logged into the system, to relay a lift request, by replaying the lift request where recorded, as communicated by the respective transmitter/receiver unit 3a, 3b, 3c without any intervention on the part of the respective lift providers, that is, without requiring the mobile communicators 5 to ring and be addressed by the respective lift providers, which advantageously allows for hands-free and voice-free reception of lift requests.

In another embodiment the mobile communicators 5 of registered lift providers could be configured, where logged into the system, to ring on receipt of a communication, and relay a lift request, by replaying the lift request where recorded, as received in the communication on being addressed by the respective lift providers.

In an alternative embodiment the transmitter/receiver units 3a, 3b, 3c could be configured such that the broadcast is a multicast to selected ones of the mobile communicators 5 in the associated geographic zone 4a, 4b, 4c.

In another alternative embodiment the transmitter/receiver units 3a, 3b, 3c could be configured to communicate individually, either serially over a single channel or at least in part simultaneously over a plurality of channels, with mobile communicators 5 in the associated geographic zone 4a, 4b, 4c, and the mobile communicators 5 of registered lift providers being configured such as to be responsive to communications so communicated by the transmitter/receiver units 3a, 3b, 3c.

The communications unit 7 comprises a control module 8 for controlling communication between respective ones of the transmitter/receiver units 3a, 3b, 3c and the mobile communicators 5, and a communicator location recording module 9 for maintaining a record of the locations of the mobile communicators 5 in the communications network. In this embodiment the communicator location recording module 9 includes a record of the location of each mobile communicator 5 in the communications network, either by reference to a specific location, as identified by a co-ordinate system, or by reference to a geographic zone 4a, 4b, 4c. Knowledge of the specific locations of the mobile communicators 5 enables communication to be established selectively with the mobile communicators 5 of available lift providers in any required spatial zone, and advantageously this spatial zone, such as a radius, need not be constrained to a geographic zone 4a, 4b, 4c associated with a respective transmitter/receiver unit 3a, 3b, 3c. Knowledge of the mobile communicators 5 in any geographic zone 4a, 4b, 4c associated with a respective transmitter/receiver unit 3a, 3b, 3c enables a multicast communication to be established with the mobile communicators 5 of available lift providers in the respective geographic zone 4a, 4b, 4c without requiring any knowledge of the specific locations of the mobile communicators 5 of the available lift providers, which thereby advantageously avoids the need to obtain specific location information for the mobile communicators 5.

The system further comprises a request matching unit 10 for matching registered lift requirers to registered lift providers. The system requires all lift requirers and lift providers to be registered in order inter alia to ensure the personal security thereof.

The registration information for each lift requirer includes details of the mobile communicator 5, in this embodiment, as cellular radio communicators, the dialling number, to be used in accessing the system, personal details, including name, age, sex, occupation, interests, etc, home address, lift provider requirements, that is, requirements of any lift provider, such as requiring one of a male or female lift provider, a lift provider of a particular age group or a lift provider from a particular locality, and account details so as to enable any charges incurred in use of the system to be debited.

The registration information for each lift provider, who can also be registered as a lift requirer, includes details of the mobile communicator 5, in this embodiment, as cellular radio communicators, the dialling number, to be used in accessing the system, personal details, including name, age, sex, occupation, interests, etc, home address, vehicle details, including registration number, make, color, age, etc, lift requirer requirements, that is, requirements of any lift requirer, such as requiring one of a male or female lift requirer, a lift requirer of a particular age group, and account details, which account details are necessary to enable any charges accrued in providing lifts to lift requirers to be credited. Where a lift provider is also to be registered as a lift requirer, the registration information includes lift provider requirements, that is, requirements of any lift provider, such as requiring one of a male or female lift provider, a lift provider of a particular age group or a lift provider from a particular locality, and account details so as to enable any charges incurred in use of the system as a lift requirer to be debited.

In other embodiments the registration information can include further information as necessary to enable the identification of any lift requirer or lift provider.

By requiring such registration information, any persons registering to the system can be vetted to ensure their standing and trustworthiness. In addition to checking the details provided against available records, it is envisaged that a check would be made to ensure that any person has no criminal record, in particular for violence, and, for any person registering as a lift provider, that the person has a full driving licence.

On registration, each person is assigned a personal identification code, in this embodiment a personal identification number (PIN), and a public identification code, in this embodiment a four-letter identity code (FLIC). The PINs are required to be kept secret, and ensure that only the person registered in respect of a respective mobile communicator 5 can access the system. The FLICs are utilized publicly to identify each registered person, and are made known to respective lift requirers and providers in order to establish the identities thereof. In being a code, the anonymity, at least in terms of name, of the respective lift requirers and providers can, if desired, be maintained.

In an alternative embodiment the FLIC could be generated, for example, through the use of a random number generator, for each lift, such that, on acceptance of a lift request by a lift provider, the lift requirer and accepting lift provider would each be assigned a respective FLIC. The use of a FLIC assigned at registration is, however, envisaged to be more practical, since this would avoid possible confusion through use of a continually changing code, it being easier to remember a FLIC which is used repeatedly, and also has the advantage of enabling lift providers to recognize regular lift requirers, which would assist lift providers in deciding whether to accept a lift request.

The request matching unit 10 comprises a lift provider logging module 11 which maintains a log of all lift providers currently logged onto the system as being available lift providers, that is, lift providers who are currently willing to provide registered lift requirers with a lift.

In this embodiment a lift provider logs onto the system by using his/her mobile communicator 5, here through an “Available” option in a displayed menu, to establish communication with the lift provider logging module 11 through the communications network, the system enabling a person to log on as one of a lift provider or a lift requirer as will be described in more detail hereinbelow, and enters his/her PIN to authenticate himself/herself to the mobile communicator 5 being used, with the identity of the mobile communicator 5 being determined from the calling line identity (CLI).

In this embodiment the system is configured such as not to allow a lift provider to log onto the system either where the CLI of the mobile communicator 5 being used is disabled, which is such as to prevent direct identification thereof, or the PIN does not match that registered for the CLI of the mobile communicator 5 being used.

In this embodiment the system is configured such that, by default, a lift provider receives a contribution from any lift requirer when sharing a journey, but can be set by a lift provider so as not to require a contribution, here through a “Contribution” option in a displayed menu.

The request matching unit 10 further comprises a request handling module 15 for handling lift requests from registered lift requirers. In this embodiment a lift requirer accesses the system by using his/her mobile communicator 5, here through a “Request” option in a displayed menu, to establish communication with the request handling module 15 through the communications network, and enters his/her PIN to authenticate himself/herself to the mobile communicator 5 being used, with the identity of the mobile communicator 5 being determined from the calling line identity (CLI).

In this embodiment the system is configured such as not to allow a lift requirer to access the request handling module 15 either where the CLI of the mobile communicator 5 being used is disabled, which is such as to prevent direct identification thereof, or the entered PIN does not match that registered for the CLI of the mobile communicator 5 being used.

In this embodiment, in making a request, a lift requirer can select from one of two request modes, a first mode where a lift requirer simply inputs information in making a lift request, and a second mode where the lift requirer is presented with certain information prior to proceeding to leave a lift request. In the first, simple mode, a lift requirer leaves a voice message stating the pick-up point, his/her destination, his/her FLIC and any other relevant information, such as that he/she is travelling with a pet. In the second mode, a lift requirer is presented with a short list of suggested pick-up points, in this embodiment with an associated map where the mobile communicator 5 of the lift requirer is enabled to receive pictoral information, such as a WAP-enabled communicator or an MMS-enabled communicator, and the number of available lift providers in his/her geographic zone 4a, 4b, 4c together with an indication as to whether those lift providers require a contribution to the cost of the journey. Where the lift requirer decides to proceed to make a lift request, he/she makes his/her way to a pick-up point, which need not necessarily be one of the suggested pick-up points, the lift requirer leaves a voice message stating the pick-up point, his/her destination, his/her FLIC and any other relevant information, such as that he/she is travelling with a pet.

In this embodiment, when a lift requirer has made a lift request, the location of the mobile communicator 5 of the lift requirer is determined from the location records of the mobile communicators 5 maintained in the communicator location recording module 9 of the communications unit 7, such as to determine the geographic zone 4a, 4b, 4c, in this embodiment the cell id, in which the mobile communicator 5 of the lift requirer is located. On determining the geographic zone 4a, 4b, 4c in which the mobile communicator 5 of the lift requirer is located, the control module 8 of the communications unit 7 acts to cause the transmitter/receiver unit 3a, 3b, 3c in the respective geographic zone 4a, 4b, 4c to broadcast the lift request to the mobile communicators 5 in the respective geographic zone 4a, 4b, 4c.

In an alternative embodiment, when a lift requirer has made a lift request, the location of the mobile communicator 5 of the lift requirer is determined from the location records of the mobile communicators 5 maintained in the communicator location recording module 9 of the communications unit 7, such as to determine the geographic zone 4a, 4b, 4c, in this embodiment the cell id, in which the mobile communicator 5 of the lift requirer is located, and, on determining the geographic zone 4a, 4b, 4c in which the mobile communicator 5 of the lift requirer is located, the mobile communicators 5 of available lift providers in the respective geographic zone 4a, 4b, 4c are then determined from the location records of the mobile communicators 5 maintained in the communicator location recording module 9 of the communications unit 7. On determining the mobile communicators 5 of available lift providers in the respective geographic zone 4a, 4b, 4c, the control module 8 of the communications unit 7 acts to cause the transmitter/receiver unit 3a, 3b, 3c in the respective geographic zone 4a, 4b, 4c to multicast the lift request to the determined mobile communicators 5 of the available lift providers in the respective geographic zone 4a, 4b, 4c.

In another alternative embodiment, when a lift requirer has made a lift request, the location of the mobile communicator 5 of the lift requirer is determined from the location records of the mobile communicators 5 maintained in the communicator location recording module 9 of the communications unit 7, such as to determine the geographic zone 4a, 4b, 4c, in this embodiment the cell id, in which the mobile communicator 5 of the lift requirer is located, and, on determining the geographic zone 4a, 4b, 4c in which the mobile communicator 5 of the lift requirer is located, the mobile communicators 5 of available lift providers in the respective geographic zone 4a, 4b, 4c are then determined from the location records of the mobile communicators 5 maintained in the communicator location recording module 9 of the communications unit 7. On determining the mobile communicators 5 of available lift providers in the respective geographic zone 4a, 4b, 4c, the control module 8 of the communications unit 7 acts to cause the transmitter/receiver unit 3a, 3b, 3c in the respective geographic zone 4a, 4b, 4c to relay individually the lift request to the determined mobile communicators 5 of the available lift providers in the respective geographic zone 4a, 4b, 4c.

The available lift providers in the respective geographic zone 4a, 4b, 4c then receive the lift request at the mobile communicators 5 thereof; the lift request being the voice message as recorded by the lift requirer, that is, including the pick-up point, the destination of the lift requirer, the FLIC of the lift requirer and other relevant information, such as that the lift requirer is travelling with a pet.

In this embodiment the lift request is relayed as communicated without any intervention on the part of the respective lift providers, that is, without requiring the mobile communicators 5 of the determined available lift providers to ring and be addressed by the respective lift providers.

In another embodiment the mobile communicators 5 of available lift providers ring on receipt of a communication, and the lift request is relayed as communicated on being addressed by the respective lift providers.

The request matching unit 9 further comprises a reply handling module 16 for handling replies from lift providers to lift requests.

On receipt of the lift request, any of the available lift providers can accept the lift request by selecting an “Accept” option. In this embodiment the mobile communicators 5 of the lift providers are configured to be voice activated, such that the available lift providers accept a lift request simply by speaking “Accept”. In another embodiment the “Accept” option can be presented in a displayed menu.

If an available lift provider believes that he/she can give the lift requirer a lift, at least part way towards his/her destination, and feels comfortable about the voice message of the lift request from the lift requirer, the lift requirer selects the “Accept” option, and a flag corresponding to the respective lift request as held by the request handling module 15 is set to a provider acceptance state. It will be appreciated that by requiring the lift request to comprise a voice message, the available lift providers can gain quite a measure of confidence from the style and tone of the voice message. The use of a voice message is also advantageous in allowing for hands-free operation, and allows the lift request to be a free-format request, as opposed to a structured request constructed using, for example, set keywords.

Following acceptance of the lift request, the reply handling module 16 acts to provide the respective active lift provider with an audible confirmation, in this embodiment a “Confirmed” voice message, followed by a repeat of the lift request, and in this embodiment a text representation of the FLIC of the lift requirer, and a representation of the pick-up point, here by one or both of a text or pictoral representation, such as a map.

The system further comprises a journey logging module 17 which is configured to log journey details for each lift request following acceptance by respective lift providers, and configure the mobile communicators 5 of respective lift requirers and lift providers to be in a journey mode, which, as will be described in more detail hereinbelow, provides for the mobile communicators 5 to have predetermined functionality, in introducing additional functions, for example, emergency and travel information functions.

In this embodiment the journey logging module 17 logs all journeys for each of the registered lift providers, and, for each lift request, logs the following details: (i) lift requirer and lift provider, (ii) vehicle registration, (iii) pick-up date, time and location, (iv) route information, including locations and times along route, (v) distance travelled, (vi) drop-off date, time and location, (vii) time period between making the lift request and acceptance by the lift provider, (viii) time to accept by the lift provider, and (ix) required contribution to the cost of the journey.

In this embodiment the locations of the mobile communicators 5 of the respective lift requirers and lift providers are recorded in a GIS database using a co-ordinate system in order to be able to fix the position of the mobile communicators 5 and hence the vehicles of respective lift providers. In embodiments the locations of the mobile communicators 5 are determined by one of triangulation or radio positioning, such as GPS. Through the use of a GIS database, distance, speed and direction can be determined and related both to the respective vehicle and the lift requirers and lift providers. In this embodiment the locations of the mobile communicators 5 of the lift requirers and lift providers can be assigned to the geographic zones 4a, 4b, 4c of the communications network.

In this embodiment this travel log information is utilized to calculate the contributions required of lift requirers to the travel costs of lift providers as determined by usage, which contributions are debited from the accounts of the respective lift requirers, and the payments to be made to lift providers as determined by usage, which payments are credited to the accounts of the respective lift providers.

The available lift provider having accepted the lift request then drives to the designated pick-up point, and, if, from appearance, the lift requirer appears acceptable to the lift provider, the lift provider approaches the lift requirer and quotes the FLIC of the lift requirer; knowledge of the FLIC confirming that the lift provider is registered to the system. If there is anything that the lift provider feels uneasy about, for example, the appearance of the lift requirer, he/she can continue with the journey and selects a “Decline” option, the lift requirer being unaware that an accepted lift request has been subsequently declined.

Where the lift requirer is approached by the lift provider, the lift requirer then utilizes his/her mobile communicator 5 to provide journey confirmation for the shared journey, in this embodiment by selecting a “Journey Confirmation” option from an available menu, and enters the vehicle registration number. The vehicle registration number is provided to the request handling module 15 to set the flag for the respective lift request to a provider confirmation state, in response to which the request handling module 15 instructs the journey logging module 17 to return, in this embodiment by text representation, the FLIC of the lift provider registered to the vehicle and confirmation as to whether the lift provider has requested a contribution towards the cost of the journey.

The lift requirer then asks the lift provider for his/her FLIC, and if the FLIC is correct, the lift requirer confirms the lift, In this embodiment by selecting a “Lift Confirmation” option from an available menu, and can enter the vehicle in the safe knowledge that the lift provider is the person registered to the vehicle. With lift confirmation, the journey logging module 17 assumes the journey mode for the respective lift request.

If there is more than one person at the designated pick-up point, the lift requirer has to identify himself/herself, in this embodiment by displaying a card bearing his/her FLIC, in order that the lift provider can identify the lift requirer.

Where the lift provider selects the “Decline” option, the flag corresponding to the respective lift request as held by the request handling module 15 is reset from the provider acceptance state to the pending state, and the lift request is re-communicated to available lift providers currently in the respective geographic zone 4a, 4b, 4c as described hereinabove, with the lift requirer being unaware that a lift provider has declined a previously-accepted lift request. Similarly, if no lift provider has accepted the initial lift request, after a short interval the lift request is re-transmitted to new lift providers having entered the respective geographic zone 4a, 4b, 4c.

The request matching unit 10 further comprises a status reporting module 19 which enables, in this embodiment by selecting a “Request Status” option from an available menu, lift requirers to obtain status reports regarding their respective requests, as typically may be sought when waiting at a pick-up point. In this embodiment the information returned includes: (i) the time period for which his/her request has been outstanding, (ii) the number of lift providers who have passed nearby, here through the respective geographic zone 4a, 4b, 4c, since the lift request was made, these lift providers being classified by the direction of travel, here by the primary compass directions North, South, East and West, and as to whether a contribution to travel costs is required, (iii) the number of available lift providers currently in the respective geographic zone 4a, 4b, 4c, and (iv) the number of declines which have been received, which information is here delayed by a random period, typically up to three minutes, so as to prevent a lift requirer associating a decline with a particular vehicle, and hence lift provider.

It is envisaged that the information in the status report would be used to modify a lift request which has proved unsuccessful. For example, a lift requirer may decide to try another pick-up point according to the relative directions of travel of available lift providers through the respective geographic zone 4a, 4b, 4c, try later where the number of available lift providers currently in the respective geographic zone 4a, 4b, 4c is low, change his/her lift request, for example, by designating a different initial direction of travel according to the relative directions of travel of available lift providers through the respective geographic zone 4a, 4b, 4c, or improve his/her appearance where a number of declines have been received.

The request matching unit 10 further comprises a travel information module 21 which enables, in this embodiment by selecting a “Travel Information” option from an available menu, lift requirers to obtain certain travel information when in the journey mode, including: (i) a list of suggested pick-up/drop-off points for the current or an alternate geographic zone 4a, 4b, 4c, (ii) the number of available lift providers in a geographic zone 4a, 4b, 4c, either the current or an alternate zone, these lift providers being classified by the direction of travel, here by the primary compass directions North, South, East and West, and as to whether a contribution to travel costs is required, and (iii) information relevant to a geographic zone 4a, 4b, 4c, either the current or an alternate zone, particularly relating to the use of the system. It is envisaged that this information will be utilized by lift requirers in deciding where to be dropped off when a further lift is required to reach his/her destination.

In this embodiment an available lift provider can share journeys with more than one lift requirer at any time, but the journey mode is maintained for each lift requirer until a termination event exists, that is, the journey mode established between the lift provider and a first lift requirer is maintained when another journey mode is established between the lift provider and a second lift requirer.

Also, in this embodiment the system enables a lift requirer to make a further lift request even where the lift requirer is currently sharing a lift, but again the existing journey mode is maintained until a termination event exists.

When the lift requirer is dropped off, no specific action is taken by the lift requirer or the lift provider. The system is configured, in the interests of security, such that the mobile communicators 5 of the respective lift requirer and lift provider remain in the journey mode until a termination event exists, which in this embodiment is either where the mobile communicators 5 of the respective lift requirer and lift provider are physically separated by a predetermined distance or a predetermined period of time has elapsed in which the mobile communicators 5 of the respective lift requirer and lift provider are static, here embodied by the mobile communicators 5 of the respective lift requirer and lift provider being in the same geographic zone 4a, 4b, 4c. This configuration prevents one of either the respective lift requirer or lift provider from disabling the emergency function of the mobile communicator 5 of the other of the respective lift requirer or lift provider.

The request matching unit 10 further comprises an emergency contact module 23 which provides for emergency contact by lift requirers or lift providers with an emergency service, typically the police, in the event of an emergency. Although the system, through the lift requesting and lift accepting operations provides a high level of security, it is understood that emergency events can occur, and the emergency contact function has been provided to provide for added personal security for both lift requirers and lift providers, and thereby engender increased confidence in the system.

In this embodiment the system is configured such that, while the mobile communicators 5 of lift requirers and lift providers are in journey mode, a communication is established with a designated emergency service, such as the police, through the application of a predetermined keystroke. In this embodiment the emergency function is enabled when a key on the respective mobile communicator 5 is pressed in quick succession, which emergency function, when actuated, causes an emergency message to be transmitted to the emergency service, which message includes details of the vehicle, including the registration number, make, color, age, etc, the current location as derived from the location of the mobile communicators 5 of the lift provider and the at least one lift requirer in the vehicle, the direction of travel and the names and addresses of the lift provider and the at least one lift requirer in the vehicle. With this information, the emergency service should be able quickly to locate and stop the relevant vehicle. In this embodiment the emergency function also discretely opens up a voice channel with the emergency service so as to enable the emergency service to listen in on conversations within the vehicle. In an alternative embodiment the operation of the emergency function to open up a voice channel is enabled by a different keystroke to that for transmitting the emergency message, here by holding down a key for an extended period of time. This emergency function enables the emergency service once contacted to follow the movement of the mobile communicators 5 of the lift provider and at least one lift requirer in the vehicle, and hence determine the location of the vehicle.

Finally, it will be understood that the present invention has been described in its preferred embodiments and can be modified in many different ways without departing from the scope of the invention as defined by the appended claims.

For example, in one embodiment the lift request could include textual information or pictoral information, such as a map of the pick-up point or a photograph, for example, of the respective lift requirer.

The system of the present invention also enables instant use where a lift requirer and a lift provider are aware that one requires a lift and the other is willing to give a lift, and yet gaining all the benefits of the inherent security.

For example, a lift provider can log onto the system in the manner described hereinabove on identifying a person requiring a lift, typically a person waiting at the roadside, at which point the lift requirer enters the FLIC of the lift provider in his/her mobile communicator 5, with the system being configured such as to confirm the lift on entry of the FLIC of the lift provider.

Also, where a lift requirer has already had a lift request accepted by a lift provider, the system is configured to enable a lift requirer to confirm a lift with another lift provider by entering the vehicle registration of the new lift provider. The system is configured to transmit a cancellation message, as one or both of a voice and text message, to the previously-accepting lift provider.

The request matching unit 10 is also configured to enable a lift requirer to bid for a taxi ride or a demand route bus service. In this mode, the lift request would be multicast to one of registered taxi providers or demand bus service providers in the respective geographic zone 4a, 4b, 4c, with the first taxi provider or demand bus service provider to select an “Accept” option receiving a “Confirmed” message and the lift request, and being automatically connected through to the lift requirer so that he/she could confirm that he/she was on his/her way. The other registered taxi providers or demand bus service providers in the respective geographic zone 4a, 4b, 4c would not receive the “Confirmed” message, and thus understand that the ride had been earlier accepted by another registered taxi provider or demand bus service provider.

1-44. (Cancelled)

45. A real-time ride-share request matching system for matching persons as lift requirers and requiring a lift to persons as lift providers and available to consider providing lifts such as to enable sharing of vehicle journeys, each of the lift requirers having a mobile communicator for making lift requests and each of the lift providers having a mobile communicator for addressing lift requests, the system comprising:
a request handling module for receiving free-format lift requests, each including a voice message, from lift requirers and storing the lift requests as received;
a communications network for relaying the stored lift requests to respective lift providers as determined by the locations of the respective lift requirers; and
a reply handling module for receiving replies from lift providers to respective lift requests in accepting the same.

46. The system of claim 45, wherein the lift request includes one or both of a textual message and a pictoral image, such as a map or photograph.

47. The system of claim 45, wherein the communications network is configured to broadcast a lift request in a spatial zone as determined by a location of the respective lift requirer.

48. The system of claim 47, wherein the broadcast is a multicast communication to available lift providers in the spatial zone.

49. The system of claim 47, wherein the communications network comprises a plurality of assigned geographic zones, with each of the geographic zones representing a spatial zone.

50. The system of claim 45, further comprising:
a communicator location recording module for recording the locations of the mobile communicators of the lift requirers and the lift providers.

51. The system of claim 45, further comprising:
a journey logging module for logging journey information.

52. The system of claim 45, wherein the request handling module is configured to provide information regarding a lift provider accepting a request to the respective lift requirer.

53. The system of claim 52, wherein the lift requirers and lift providers are each registered and have an access code to enable access to the system and an identification code for providing a means of identification, and the request handling module is configured, for a lift request, to receive vehicle identification information from the mobile communicator of the respective lift requirer and transmit the identification code of the accepting lift provider to the mobile communicator of the respective lift requirer such that, where the identification code received by the respective lift requirer matches the identification code given by the respective lift provider, the lift is confirmed.

54. The system of claim 53, further comprising:
a journey logging module for logging journey information, wherein the journey logging module logs the respective lift requirer and lift provider as being in a journey mode.

55. The system of claim 54, wherein the journey logging module is configured to release the logged journey mode for a respective lift requirer and lift provider where the lift requirer and the lift provider are one of separated by a predeterminable distance or a predeterminable period has elapsed in a static location.

56. The system of claim 45, further comprising:
an emergency contact module for alerting an external agent on receiving an emergency signal from the mobile communicator of a lift requirer or a lift provider, the emergency contact module being configured to transmit details of the vehicle and the lift requirer and lift provider in the vehicle in which the lift requirer or lift provider who issued the emergency signal is located.

57. A real-time ride-share matching method for matching persons as lift requirers and requiring a lift to persons as lift providers and available to consider providing lifts such as to enable sharing of vehicle journeys, each of the lift requirers having a mobile communicator for making lift requests and each of the lift providers having a mobile communicator for addressing lift requests, the method comprising the steps of:
receiving free-format lift requests, each including a voice message, from lift requirers;
storing the lift requests as received;
relaying the stored lift requests to respective lift providers as determined by the locations of the respective lift requirers; and
receiving replies from lift providers to respective lift requests in accepting the same.

58. The method of claim 57, wherein the lift request includes one or both of a textual message and a pictoral image, such as a map or photograph.

59. The method of claim 57, wherein the step of relaying lift requests comprises the step of:
broadcasting a lift request in a spatial zone as determined by a location of the respective lift requirer.

60. The method of claim 59, wherein the broadcast is a multicast communication to available lift providers in the spatial zone.

61. The method of claim 59, wherein a communications network comprises a plurality of assigned geographic zones, with each of the geographic zones representing a spatial zone.

62. The method of claim 57, further comprising the step of:
recording the locations of the mobile communicators of the lift requirers and the lift providers.

63. The method of claim 57, further comprising the step of:
logging journey information.

64. The method of claim 57, further comprising the step of:
providing information regarding a lift provider accepting a request to the respective lift requirer.

65. The method of claim 64, wherein the lift requirers and lift providers are each registered and have an access code to enable access to the system and an identification code for providing a means of identification, and further comprising the steps of:
receiving vehicle identification from the mobile communicator of the lift requirer;
in response to receipt of vehicle identification, logging the lift requirer and lift provider as being in a journey mode; and
transmitting the identification code of the lift provider to the mobile communicator of the lift requirer such that, where the identification code received by the lift requirer matches the identification code given by the lift provider, the lift is confirmed.

66. The method of claim 65, further comprising the step of:
logging journey information;
wherein the step of logging journey information comprises the step of:
logging the respective lift requirer and lift provider as being in a journey mode.

67. The method of claim 66, wherein the logged journey mode is released for a respective lift requirer and lift provider where the lift requirer and the lift provider are one of separated by a predeterminable distance or a predeterminable period has elapsed in a static location.

68. The method of claim 57, further comprising the step of:
alerting an external agent on receiving an emergency signal from the mobile communicator of a lift requirer or a lift provider, including transmitting details of the vehicle and the lift requirer and lift provider in the vehicle in which the lift requirer or lift provider who issued the emergency signal is located.
